(19) United States
(12) Patent Application Publication
(10) Pub. No.: US 2010/0175630 A1
(43) Pub. Date: Jul. 15, 2010

(54) Window Bird House

(76) Inventor: Michael A. Stetson, Lake Elsinore, CA (US)

Correspondence Address: STETINA BRUNDA GARRED & BRUCKER, 75 ENTERPRISE, SUITE 250, ALISO VIEJO, CA, 92656, US

(21) Appl. No.: 12/352,741

(22) Filed: Jan. 13, 2009

(51) Int. Cl. A01K 31/14

(52) U.S. Cl. 119/431; 119/428; 119/435

(57) ABSTRACT

A window bird house is advantageously configured for easy transport and storage, and is a low cost alternative to prior art bird houses. The window bird house includes a housing having a plurality of walls and a floor which are collapsible upon each other for compact transport and storage. One of the walls includes a viewing opening for observing birds in the housing. Additionally, the rear wall may be removably secured to a first side of a window so that inside of the housing is visible from a second side of the window. Also, one of the walls includes an opening for ingress and egress of birds. A cover may be attached to the second side of the window for selecting covering the viewing opening thereby mitigating disruptions to the birds. The window bird house may be fabricated from die cut corrugated plastic sheet.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to bird houses, and more particularly to a window bird house that is easy to assemble, low cost to manufacture, and designed with a window for observing nesting birds.

2. Description of the Related Art

Bird watching is a popular activity that includes the observation and study of birds with the naked eye or through a visual enhancement device like binoculars. Different species of birds come in a variety of colors, shapes, and sizes. In order to enjoy the visual appeal of birds, homeowners often employ a bird house or a bird feeder in their yard to provide a venue to attract birds. A bird house is generally placed outdoors, where they are accessible for birds, and supplies food to birds while also providing an enclosure for birds to nest. Ideally, a bird house has an inviting décor and is designed to detract predators from entering the enclosure.

The success of a bird house in attracting various species of birds depends upon its placement and the kinds of nourishment offered, as different species have different preferences. Bird houses are often constructed in a manner so that they are aesthetically pleasing while also being ventilated and durable. Properly ventilated bird houses promote consistent and safe temperatures by promoting the circulation of air while also providing an adequate oxygen supply for the birds.

The majority of bird houses are cuboid, and many have a sloping roof to divert water away from the enclosure. Additionally, many have a hinged top to provide access for cleaning. Generally bird houses either have an entrance opening. Some bird houses may be highly decorated to attract various species of birds. Additionally, designs mimicking a house design or other structures are common in some gardens to provide aesthetic appeal and to incorporate the bird house into the décor of the garden or house.

The construction methods employed to build bird houses often vary depending on geographic locale and type of bird species sought to attract. In this regard, in routinely warm and dry climates it is critical to construct a bird house such that it is sufficiently ventilated. Likewise, in cold and wet climates it is critical to construct a bird house with adequate drainage to divert water from accumulating within the bird house. Generally, a bird house is constructed with wood, though some are made from concrete or mixtures of wood and concrete, called woodcrete. However, wooden bird houses are often difficult to assemble as they require tools such as a hammer and nails for assembly. This is particularly tedious and potentially hazardous for children who are common bird watchers and owners of bird houses.

Additionally, wooden bird houses are bulky and heavy in weight which detracts from their commercial appeal as they occupy additional shelf space at retail stores and are costly to ship which is increasingly becoming a design consideration in light of e-commerce supply chain trends. Metal nest boxes are also marketed, but these are generally unsuitable for outdoor use, as they can overheat easily in sunshine. The commercial viability of bird houses depends on designs that are easy to assemble, low cost, and easy to transport. This is particularly evident if the intended consumer is a child as attention must be given to assembly without requiring tools that may be dangerous in the hands of children.

As most conventional bird houses are placed in outdoor gardens, bird watchers are unfortunately unable to view nesting birds from the comfort and convenience from their homes.

Therefore, there is currently a need in the art for an improved bird house.

### BRIEF SUMMARY

There are provided multiple embodiments of a bird house for observing nesting birds. The bird house may be designed to conveniently attach to the window of a structure such as a house, building, or the like, and enables bird watchers to observe nesting birds while indoors. The bird house is advantageously configured for easy transport, storage and assembly, and is a low cost alternative to prior art bird houses currently in the market. In an embodiment, the bird house comprises a housing. It is contemplated that the housing may be sized to fit at least one bird. Although various species of birds have different sizes, it is contemplated that the bird house may accommodate any species of bird. The housing includes a front wall which may have an opening for ingress and egress of birds.

The housing further includes a rear wall that may have a viewing opening, or a window, for observing birds in the housing. As a result, nesting birds may be viewed in the housing. Therefore, bird watchers may enjoy the unique appearance of birds while also surveying their nesting and eating habits through a conveniently sized opening without disrupting the birds. The rear wall may be removably secured to a first side of a window so that the housing is visible from a second side of the window. It is contemplated that the bird house may be affixed to a window of any structure, such as a house or a building. However, the bird house should be placed at a height that is approachable and attractive to birds. Bird watchers may conveniently view birds cohabiting the bird house through the window while indoors. Additionally, bird watchers may monitor birds with the naked eye and may even record their observations with cameras and recording equipment which may be placed inside the housing. This is particularly beneficial for educating children who have a natural curiosity towards birds.

The housing may further include a floor for supporting nesting birds. The construction of the housing is generally rigid and durable to withstand the weight of at least one bird, a nest, and additional food and nourishment. Additionally, the housing is designed to bear the natural activity of birds. The housing may be ventilated to promote the circulation of air and may also include perforations for draining any standing water accumulated within the housing.

The housing further includes a right side wall and a left side wall, each being removably coupled with the floor, the front wall, and the rear wall. It is contemplated that each of the left and right side walls is designed to divert water away from the housing. In this regard, the housing may be configured having a triangular shape such that the left and right side walls converge to define a top edge and thereby divert water, such as from rain or snow, away from the opening. It is contemplated that the housing may include a top wall secured to the side walls. The top wall may be peaked to divert water or falling objects on the housing.

The bird house further includes a cover having an upper portion and a lower portion. The cover is securable to the second side of the window for covering the viewing opening. The cover may be employed on the opposite side of the window the bird house is affixed to. In this regard, bird watchers may utilize the cover, while indoors, when not observing the nesting birds such that the birds are not interrupted. It is contemplated that the cover is sized and dimensioned to at least cover the entire viewing opening of the rear wall. The cover advantageously shields birds from artificial elements. Specifically, the cover advantageously shades any light from entering the housing and may mute sounds from distracting the birds. This is particularly useful at night so that artificial light does not interrupt nesting birds. However, it is contemplated that the cover may be employed at any time of day when the bird watcher does not intend to observe birds within the housing to shield the bird from the bird watchers during these times.

The cover may include a fold line between the upper and lower portions, and the cover may be foldable at the fold line. The upper portion may be secured to the second side of the window. The lower portion may normally cover the viewing opening and be folded up when looking through the viewing opening. It is also contemplated that either the lower portion or the upper portion, or both may be detached to view inside of the housing. Additionally, it is contemplated that the lower portion of the cover may be removably secured to the second side of the window via adhesives, hooks and loops, or the like.

The window bird house is easy to assemble and transport, and is rigid and durable to withstand the rigors of nature and the routine activity of birds. In this regard, the housing may be fabricated from a durable material such as corrugated plastic or cardboard and the like. However, it is contemplated that any durable material having a foldable quality may be sufficient for constructing the housing. Additionally, the window bird house may be manufactured from die cut panels to foster mass production at low cost. Additionally, the housing may be fabricated from a unitary material having a plurality of foldable sections. Each foldable section may define the front wall, the right side wall, the left side wall, the rear wall, and the floor. It is contemplated that the unitary material may include a plurality of predetermined fold lines identifying each foldable section. The fold lines allow the bird house to be easily assembled as the arrangement of each wall defining the housing is visible. The basic assembly requirements are particularly beneficial for children.

The housing walls may be assembled using adhesives, latch elements, and/or the like. Specifically, the right side wall and the left side wall may be removably coupled with the front wall and the rear wall by a plurality of latch elements. Each of the latch elements may include a tab-receiving slot operable to receive and cooperatively engage a projecting locking tab. It will be appreciated that the assembly of the bird house does not require the use of any tools such as hammers and nails.

The bird house may include structures for supporting birds such as bird feeders, ledges, and the like. Such structures may be affixable within the housing or externally upon the housing walls. In an exemplary embodiment, the front wall may include a support ledge for supporting birds.

The bird house is designed for easy transport, and is compact thereby requiring limited retail shelf space. In this regard, each housing wall may be configured for pivotal collapse. As a result, each housing wall may pivot downwards and collapse upon the floor. Consequently, the housing may take a generally flat compact form that requires minimal space.

It will be appreciated that the window bird house apparatus provides an easy to assemble, low cost bird house for observing nesting birds while indoors.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a window bird house affixed to a first side of a window;

FIG. 2 illustrates an alternative view of the window bird house depicting the cover attached to the second side of the window and being folded upward revealing the viewing opening of the rear wall;

FIG. 3 illustrates an exploded view of the window bird house depicting the housing, the cover, and a support ledge configured to affix upon the front wall;

FIG. 3A illustrates a close up view of corrugated plastic that is used to fabricate the window bird house, the corrugated plastic includes twinwall plastic sheet to provide rigid support to the housing;

FIG. 4 illustrates the window bird house in a compacted form for storage or transport; and

FIG. 5 illustrates an exploded view of the window bird house depicting the housing, the support ledge, and the cover, the housing is fabricated from a unitary material having fold lines defining each housing wall.

Common reference numerals are used throughout the drawings and the detailed description to indicate the same elements.

### DETAILED DESCRIPTION

The detailed description set forth below in connection with the appended drawings is intended as a description of one presently preferred embodiment of the bird house, and is not intended to represent the only form in which the bird house may be developed or utilized. The description sets forth the functions of the bird house in connection with the illustrated embodiment. It is to be understood, however, that the same or equivalent functions may be accomplished by different embodiments. It is further understood that the use of relational terms such as first and second and the like are used solely to distinguish one from another entity without necessarily requiring or implying any actual such relationship or order between such entities.

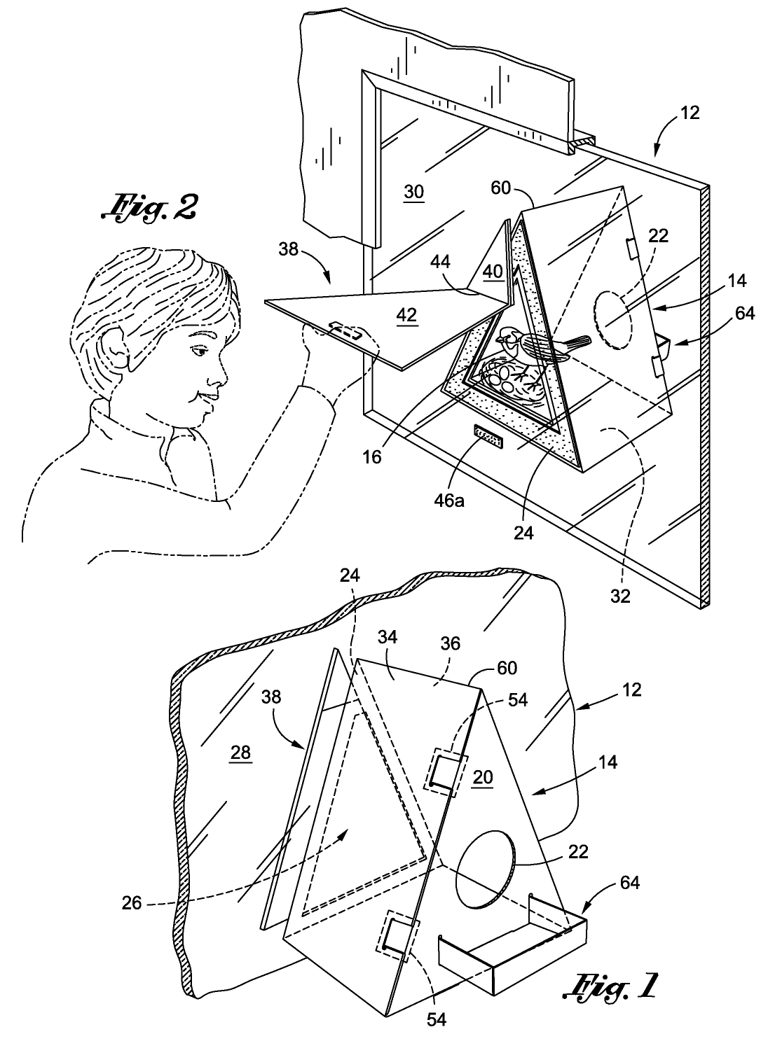

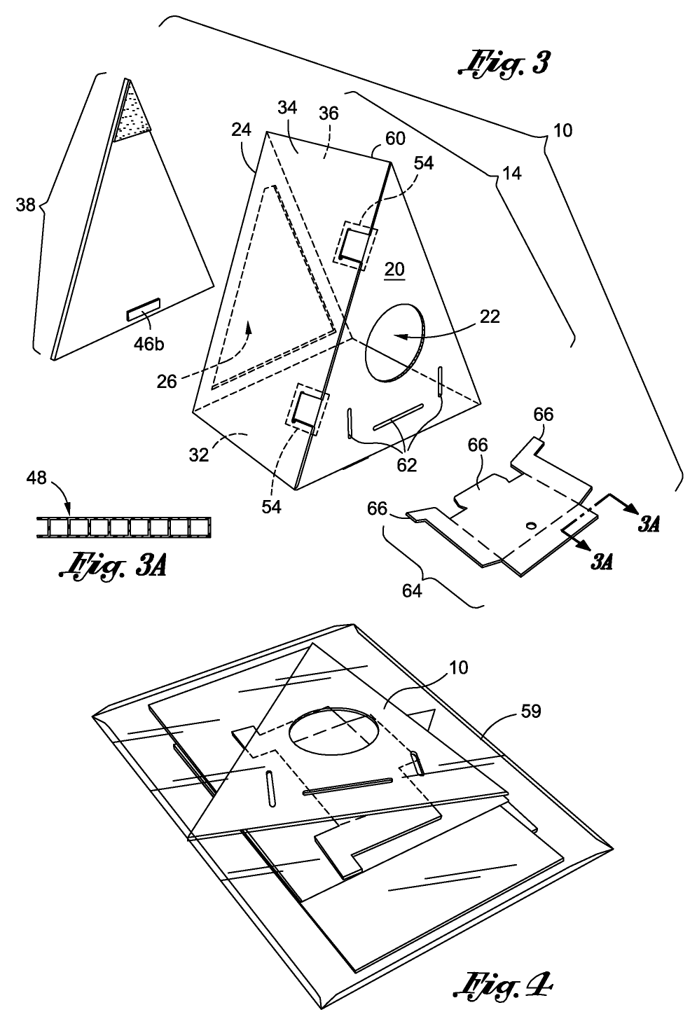

In accordance with one aspect of the bird house, there is provided a window bird house which provides a low cost, easy to assemble and easy to manufacture bird house that permits users to view nesting birds 16 through a viewing opening. As shown in FIGS. 1 and 2, the bird house 10 is designed to conveniently attach to a window 12 of a structure such as a house, building, or the like and permit bird watchers to observe nesting birds 16 while indoors.

The bird house 10 may comprise a housing 14 (see FIG. 3). It is contemplated that the housing 14 may be sized to fit at least one bird, a nest for a bird, and sufficiently dimensioned so that food and water may be placed in the housing 14. Additionally, it is contemplated that the housing 14 is durably constructed to withstand the weight of birds 16 and additional supplies such as food, water, and artificial structures such as ledges, bird feeders, and the like. Different species of birds 16 require different sized housings 14. For example, most cavity nester bird species such as the Eastern Bluebird, House Wren or Chickadee can comfortably nest in a bird house built for a single nest. Whereas, Purple Martins are known to nest in bird houses built for multiple birds. It is contemplated that the housing 16 may be sized and dimensioned to accommodate the nesting habits of any species of bird.

The housing 14 may include a front wall 20 (see FIG. 3), a rear wall 24 (see FIG. 5), a right side wall 34 (see FIG. 3), a left side wall 36 (see FIG. 3), and a floor 32 (see FIG. 3). The front wall 20 includes an opening 22 for ingress and egress of birds 16. The opening 22 is sufficiently sized and shaped to accommodate various species of birds 16. The opening 22 may be a sufficiently sized circular hole. However, the opening 22 may be configured as any shape that is sufficiently sized to permit ingress and egress of the birds 16. A person having ordinary skill in the art will recognize that the opening 22 may also be configured upon another wall of the housing 14 (e.g., left sidewall or right sidewall).

The housing 14 further includes the rear wall 24 having a viewing opening 26 for observing birds 16 in the housing 14. Consequently, bird watchers may observe nesting birds 16 through the viewing opening 26. The rear wall 24 may be removably secured to a first side 28 (see FIG. 1) of the window 12 so that the housing 14 is visible from a second side 30 (see FIG. 2) of the window 12. Any conventional fastener may secure the housing 14 upon the window 12. By way of example and not limitation, the perimeter of the rear wall 24 may include double-sided tape securing the housing 14 to the first side 28 of the window 12, as shown in FIG. 2. Alternatively, the housing 14 may be secured to the first side 28 of the window 12 via suction cups or epoxy. The bird house 10 may be affixed to the window 12 of any structure, such as a house or a building. However, the bird house 10 should be placed at a height that is approachable and attractive to birds 16. Different species of birds 16 prefer nesting at various heights. For example, Catbirds are known to prefer nesting near the ground, whereas Mourning Doves are known to nest at higher altitudes. It is contemplated that the present bird house 10 may be affixed at any height to accommodate any species of bird 16. Additionally, the bird house 10 is designed to withstand the weight of such bird species such that the bird house 10 remains rigidly affixed to the window 12.

The floor 32 supports nesting birds 16 in the housing 14. It is contemplated that the construction of the housing 14 is rigid and durable to withstand the weight of at least one bird, a nest, and additional food and nourishment. The floor 32 may be configured to provide additional comfort for the birds 16 by providing padding and the like. Additionally, the floor 32 may be ventilated to promote the circulation of air and may also include perforations for draining any standing water that is accumulated within the housing 14.

The right side wall 34 and the left side wall 36, of the housing 14 may be rotateably coupled to the floor 32. The right and left sidewalls 34, 36 may be securable to the front wall 20 and the rear wall 24. Each side wall 34, 36 may be designed to divert water away from the housing. In an alternative embodiment, it is contemplated that the housing 14 may include a top wall (not shown) secured to the side walls 34, 36. The top wall may be peaked or bowed to divert water or falling objects away from the housing 14. Additionally, in an alternative embodiment, any wall of the housing 14 may have the opening 22 for ingress and egress of birds 16.

The bird house 10 may further include a cover 38 (see FIG. 2) having an upper portion 40 and a lower portion 42. The cover 38 may be removably secured to the second side 30 of the window 12 for selectively covering the viewing opening 26. The cover 38 may be employed on the opposite side of the window 12 that the housing 14 is affixed upon. In this regard, bird watchers may utilize the cover 38, while indoors, when not observing birds 16 nesting in the housing 14. It is contemplated that the cover 38 is sized and dimensioned to at least cover the entire viewing opening 26 of the rear wall 24. The cover 38 advantageously allows bird watchers to observe birds 16 while indoors and also shields nesting birds 16 from disruptions when the bird watcher is not observing the bird. Specifically, the cover 38 advantageously shades the housing 14 from artificial indoor light. This is particularly useful at night so that artificial light does not interrupt nesting birds 16. Also, the cover 38 minimizes the bird's view of humans. It is contemplated that the cover 38 may be employed at any time of day when the bird watcher is not observing the birds 16 within the housing 14.

The cover 38 is foldable so that the user may simply fold the cover 38 to observe the bird 16 within the housing 14. The cover 38 may include a fold line 44 (see FIG. 2) positioned between the upper and lower portions 40, 42. In this regard, the bird watcher does not need to detach both the upper and lower portions 40, 42 to view inside the housing 14, but rather the inside of the housing 14 may be viewed by conveniently folding the lower portion 42 upward so that the viewing opening 26 is uncovered. Conversely, it is contemplated that the inside of the housing 14 may be viewed by conveniently folding the upper portion 40 downward so that the viewing opening 26 is uncovered. It is contemplated that either the lower 42 portion or the upper 40 portion, or both may be detached to view inside of the housing 14. Additionally, it is contemplated that the cover 38 is removably secured to the second side 30 of the window 12 via adhesives, hooks and loops (i.e., Velcro®), or the like. The upper portion 40 may be adhesively affixed to the second side 30 of the window 12 with double-sided tape and the lower portion 42 of the cover 38 may be detachedly affixed to the second side 30 of the window 12 with hooks and loops. For example, the second side 30 of the window 12 may have a first part 46a (see FIG. 2) of a hooks and loops system. The lower portion 42 of the cover 38 may have a second part 46b (see FIG. 3) of the hooks and loops system. The first and second parts 46a, b may respectively be hooks and loops, or vice versa. The first part 46a on the second side 30 of the window 12 may be detachably attached to the second part 46b of the hooks and loops system attached to the lower portion 42 of the cover 38. It is contemplated that any method may be employed to removably secure the lower portion 42 of the cover 38 to the second side 30 of the window 12 such as adhesives, epoxy, suction cups, or the like. Additionally, the cover 38 may include a handle (not shown) for facilitating folding or unfolding of the cover 38.

It is contemplated that the bird house 10 is easy to assemble and transport, and is rigid and durable to withstand the rigors of natural elements and the activity of birds. In this regard, the housing 14 may be fabricated from a durable material such as corrugated plastic 48, cardboard, fiberboard, and the like. By way of example and not limitation, the housing 14 is fabricated from corrugated plastic 48, as illustrated in FIG. 3A. The corrugated plastic 48 may be a twinwall plastic sheet. The twinwall design provides lightweight durable support to the bird house 10. Generally, the corrugated plastic 48 is produced from high impact polypropylene resin and is a light weight tough material which can be folded and die cut and scored. The housing 14 may be constructed of corrugated plastic 48 having a width of ⅛ inch. Additionally, the exterior of the bird house 10 may be decorated or painted in a variety of colors.

The bird house 10 may be constructed from die cut corrugated plastic 48. A die is a specialized tool used in manufacturing industries to cut, shape and form a wide variety of products and components. Like molds and templates, dies are generally customized and uniquely matched to the product they are used to create. As a result, a mass produced die cut housings 14 provide a low cost alternative to current bird houses on the market. The die cut manufacturing promotes mass production and maintains lower manufacturing costs. Additionally, the housing 14 may be fabricated from a unitary material having a plurality of foldable sections 50, as shown in FIG. 5. FIG. 5 illustrates the housing 14 as a unitary material. It will be appreciated that the housing 14 may be constructed to limit seepage of water into the housing 14 when erected. Specifically, each of the foldable sections 50a, b, c, d, e defines the front wall 20, the right side wall 34, the left side wall 36, the rear wall 24, and the floor 32 respectively. The unitary material includes a plurality of fold lines 52 identifying each foldable sections 50a-e.

Therefore, the housing 14 fabricated from die cut corrugated plastic 48 and constructed from a unitary material having foldable sections 50 is easy to assemble, transport, and store. Furthermore, the fold lines 44 allow the bird house 10 to be easily assembled as the arrangement of each wall defining the housing 14 is visible.

The housing walls may be removably secured to each other by an adhesive, latch elements, or the like. The front wall 20 and the rear wall 24 may be removably coupled to the right and left side walls 34, 36 and the floor 32 by a plurality of latch elements 54 (see FIG. 3). The latch element 54 may include a tab-receiving slot 56 (see FIG. 5) operable to receive and cooperatively engage a projecting locking tab 58 (see FIG. 5). The front and rear walls 20, 24 may be configured with locking tabs 58. The side walls 34, 36 and the floor 32 are configured with complimentary slots 56. The latch elements 54 provide for a durable and rigid assembly of the housing 14 without requiring the use of tools. A person having ordinary skill in the art will understand that any attachment connector that provides a rigid connection between the walls such as hooks and loops, hinges and fasteners, adhesives or the like may be utilized to secure the walls together. However, the cost of utilizing latch elements 54 is relatively inexpensive as compared to the alternative means. The housing 14 may be mass-produced as a unitary die cut sheet having latch elements 54. One or more dies that is specially designed in accordance with the dimensions of the housing 14, cover 38 and ledge 64 facilitates the mass production of the housing 14, cover 38 and the ledge 64. Additionally, the latch elements 54 may allow bird watchers to easily assemble and dissemble the bird house 10. The latch element 54 may allow for assembly of the bird house 10 without the use of tools.

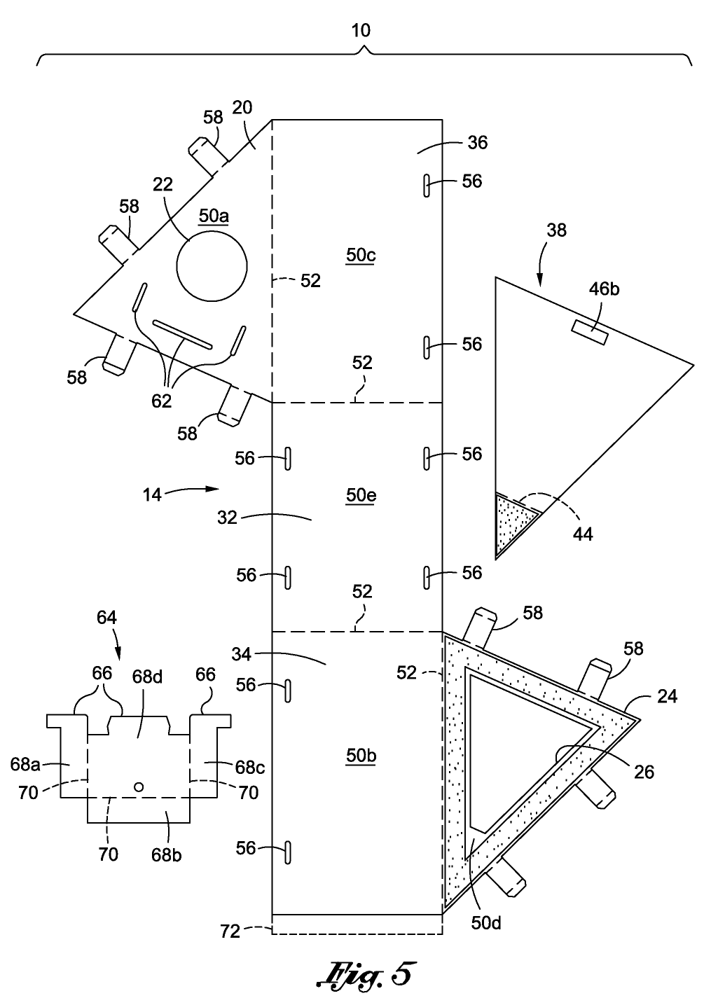

Additionally, the bird house 10 is advantageously packaged so that it is space efficient for easy transportation and takes limited storage on commercial shelves. In this regard, the foldable sections 50 of the unitary material are collapsible to fold into a generally flat and compact component, as shown in FIG. 4. FIG. 4 illustrates the bird house 10 in a collapsed and folded position stuffed into an envelope 59. The collapsed position of the bird house 10 is easy to transport via mail or courier, which is a common means of transport for goods sold over the Internet. Manufacturers of bird houses 10 would prefer to keep shipping and storage costs low by developing bird houses 10 that are light weight and capable of folding into convenient marketable packages that consumers may purchase at pet specialty stores or conveniently order through the Internet.

The bird house 10 may be configured to divert water from entering into the housing 14. Standing water that accumulates in the housing 14 may foster the breeding of parasites that are harmful to birds 16. In this regard, the housing 14 is configured to have a triangular shape so that the right side wall 34, the left side wall 36, the front wall 20, and the rear wall 24 converge and define a top edge 60. Resultantly, any water that falls on top of the bird house 10 is diverted down the side walls 34, 36 and away from the front 20 and rear walls 24 which have openings 22, 26. Optionally, the right or left sidewalls 34, 36 may have an additional lip 72 (see FIG. 5) that may be folded over the top edge 60 and attached to the opposite sidewall. It is also contemplated that the housing 14 may be weatherproofed. For example, tape or other water impermeable sheet may be adhered to the edges of two adjacent walls 34, 36, 20, 24.

In an exemplary embodiment, the bird house 10 may include a top panel (not shown) defining the top of the housing 14. It is contemplated that the top panel may be configured in a variety of shapes to attract birds and may be sloped or curved to divert water from the inside of the housing 14.

The bird house 10 may be outfitted with structures for supporting birds 16 such as ledges 64, bird feeders, and the like. Such structures may be removably affixed within the housing 14 or may be positioned upon any of the housing walls. By way of example and not limitation, the housing 14 may be configured to hold the ledge 64 for supporting birds 16. The ledge 64 may include a plurality of tabs 66 cooperatively engageable with a plurality of slots 62 in the front wall 20. However, it is contemplated that the ledge 64 may be affixed to the housing 14 using any affixing method such as adhesives, fasteners, or the like. Additionally, the ledge 64 is configured to be foldable and easy to assemble. In this regard, the ledge 64 includes foldable sections 68a, b, c identified by foldable lines 70. The wall 68b may be secured to the walls 68a, c with adhesives, tape, latching elements and the like or any other methods known in the art or developed in the future.

The above description is given by way of example, and not limitation. Given the above disclosure, one skilled in the art could devise variations that are within the scope and spirit of the invention disclosed herein, including various ways of securing the bird house to the window. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A bird house for viewing nesting birds through a window of a structure, the bird house comprising:
a housing including:
a floor for supporting nesting birds;
a left side wall;
a right side wall;
a front wall with an opening for ingress and egress of birds; and
a rear wall having a viewing opening for viewing birds in the housing, the rear wall having an adhesive for securing the housing to a first side of the window;
wherein the floor, left side wall, right side wall, front wall and the rear wall are fabricated from a first unitary sheet of material and defines at least four fold lines, and the floor, left side wall, right side wall, front wall and the rear wall are collapsible to a generally flat configuration;
a latching mechanism formed in two or more of the floor, left side wall, right side wall, front wall and the rear wall for maintaining the housing in an erected state;
a cover having an upper portion and a lower portion defined by a fold line, the upper portion having an adhesive for securing the upper portion to a second side of the window, the lower portion being removeably securable to the second side of the window for selective viewing of the birds in the housing, the cover being fabricated from a second unitary sheet of material.

2. The bird house of claim 1 further comprising a ledge for supporting birds, the ledge being attachable to the front wall of the housing beneath the opening.

3. The bird house of claim 2 wherein the housing, cover and ledge are fabricated from a unitary die cuttable sheet of material.

4. The bird house of claim 1 wherein the housing is fabricated from corrugated plastic or corrugated paper.

5. The bird house of claim 1 wherein:
the floor has a rectangular configuration defining first, second, third and fourth sides;
the left side wall is rotateably attached to the floor on the first side;
the right side wall is rotateably attached to the floor on the third side;
the front wall is rotateably attached to the right side wall and securable to the floor on the second side; and
the rear wall is rotateably attached to the left side wall and securable to the floor on the first side.

6. The bird house of claim 1 wherein the latching mechanism comprises a projecting tab formed in one of the floor, left side wall, right side wall, rear wall, front wall and floor and a corresponding slot formed in a different one of the floor, left side wall, right side wall, rear wall, front wall and floor.

7. The bird house of claim 1 wherein the latching mechanism is an adhesive tape or staple.

8. The bird house of claim 1 wherein the adhesive is a double sided tape, epoxy or adhesive layer.

9. A bird house for viewing nesting birds through a window of a structure, the bird house comprising:
a housing including:
a front wall having an opening for ingress and egress of birds;
a right side wall and a left side wall which are attached to the front wall;
a rear wall having a viewing opening for viewing birds in the housing, the rear wall being attachable to a first side of the window such that the housing is visible from a second side of the window, the rear wall being attached to the right and left side walls; and
a floor for supporting nesting birds, the floor being attached to the front wall, the rear wall, and the left and right side walls; and
a cover having an upper portion and a lower portion, one of the upper and lower portions being attachable to the second side of the window for covering the viewing opening, and the other one of the upper and lower portions being removeably securable to the second side of the window for covering the viewing opening.

10. The bird house of claim 9 wherein at least two or more of the front wall, right side wall, left side wall, rear wall and the floor are detached from each other such that the housing is generally flat with the front wall, right side wall, left side wall, rear wall and the floor are folded upon each other.

11. The bird house of claim 10 wherein the cover includes a fold line between the upper and lower portions, and the cover being foldable at the fold line.

12. The bird house of claim 11 wherein the upper portion has an adhesive for adhesively securing the upper portion of the cover to the second side of the window, the lower portion has a first part of a hooks and loops system and a second part of the hooks and loops system is attachable to the second side of the window.

13. The bird house of claim 9 wherein the front and rear walls are removably coupled to the right and left sidewalls and the floor by a plurality of latch elements, the latch elements including a tab receiving slot operable to receive and cooperatively engage a projecting locking tab.

14. The bird house of claim 9 wherein the housing and the cover are fabricated from die cut corrugated plastic.

15. The bird house of claim 14 wherein the housing and cover are ⅛ inch wide.

16. The bird house of claim 9 wherein the housing is fabricated from a unitary material having a plurality of foldable sections identified by folding lines, the foldable sections defining the front wall, the right side wall, the left side wall, the rear wall, and the floor.

17. The bird house of claim 9 wherein the housing has a triangular shape such that the left side wall and the right side wall converge to define a top edge.

18. The bird house of claim 9 further comprising a support ledge attachable to the front wall.

19. The bird house of claim 18 wherein the front wall includes at least one tab receiving slot and the support ledge has a corresponding projecting locking tab, the at least one tab receiving slot operable to receive and cooperatively engage the corresponding projecting locking tab of the support ledge.

20. The bird house of claim 9 wherein the front wall, the rear wall, and the left and right side walls are configured for pivotal collapse upon the floor.

21. The bird house of claim 9 wherein the rear wall has adhesive for adhesively securing the housing to the first side of the window.

22. The bird house of claim 9 wherein the rear wall abuts the first side of the window.
